(19) United States
(12) Patent Application Publication
(10) Pub. No.: US 2011/0222892 A1
(43) Pub. Date: Sep. 15, 2011

(54) DENSITY SENSOR AND IMAGE FORMING APPARATUS INCLUDING THE SAME

(75) Inventors: Masafumi HASHIGUCHI, Yokohama-shi (JP); Tomohide URAZATO, Atsugi-shi (JP); Norifumi YAMAMOTO, Yokohama-shi (JP); Masahiko SATO, Sagamihara-shi (JP); Toshio YANATA, Ebina-shi (JP); Tetsuya HIRATA, Atsugi-shi (JP)

(73) Assignee: RICOH COMPANY, LTD., Tokyo (JP)

(21) Appl. No.: 13/047,199

(22) Filed: Mar. 14, 2011

(30) Foreign Application Priority Data
Mar. 15, 2010 (JP) 2010-056979

(51) Int. Cl. G03G 15/00; G01B 11/00

(52) U.S. Cl. 399/74; 356/625

(57) ABSTRACT

A density sensor detects a density of a subject according to a variation in received light. The density sensor comprises a base plate, a light emitting element irradiating a subject with light, the light receiving element receiving light reflected by the subject, lead terminals connected at one end with bottoms of the light emitting and receiving elements, respectively, and electrically connected at the other end with the base plate, and a package containing the light emitting and receiving elements and supported by the base plate, wherein at least one of the lead terminals is configured to be inclined from a halfway position so as to reflect light from the light emitting element in a direction away from the bottom of the light receiving element.

### CROSS REFERENCE TO RELATED APPLICATION

The present application is based on and claims priority from Japanese Patent Application No. 2010-56979, flied on Mar. 15, 2010, the disclosure of which is hereby incorporated by reference in its entirety.

### BACKGROUND OF THE INVENTION

1. Field of the Invention

The present invention relates to a density sensor which comprises a light emitting element and a light receiving element in a single package mounted on a base plate as well as to an image forming apparatus incorporating such a density sensor.

2. Description of the Prior Art

In prior art an image forming apparatus such as a copier, a printer, or a facsimile machine comprises a density sensor to optically detect density of a toner patch formed on a photoreceptor or a transfer belt. Thereby, it can adjust density of images based on a result of the detection and generate images with constant density.

Japanese Patent Application Publication No. 2006-267644 discloses a density sensor which comprises a light emitting element and light receiving elements in a single package, for example. A toner patch on an intermediate transfer belt is irradiated with light from the light emitting element, and the light is reflected thereby to be specular light and diffusive light. The specular and diffusive lights are received by a specular light receiving element and a diffusive light receiving element, respectively.

This prior art density sensor is described with reference to FIG. 6. FIG. 6 shows that a light emitting element 01 and two light receiving elements 02, 03 are held in a package 04 and FIG. 7 shows that the package 04 holding the light receiving element 03 is supported on a base plate 06 by way of example. The element 03 is disposed in the package 04 so that the optical axis 0 is parallel to the base plate 06 as shown in FIG. 7. A lead terminal 05 is connected with the bottom of the light receiving element 03. It extends along the base plate 06, is bent to a direction orthogonal to the optical axis, inserted through the base plate 06 and soldered with the base plate 06.

The base plate 06 is coated with a light blocking material to prevent stray light from being received by the light receiving elements 02, 03. This density sensor aims to improve detection accuracy by blocking light from the light emitting element 01 from entering the base plate 06.

However, there is a problem with the density sensor that it cannot prevent the light receiving elements from receiving unintended light not reflected by a subject of density detection. This leads to a decrease in density detection accuracy. Specifically, light may leak from the bottom of the elements 01 to 03 although the elements are surrounded by the package 04. The lead terminal 05 is configured to bend at a bend portion 05a in a direction parallel to the bottom of the element 03 as shown in FIG. 7. Because of this, the leaked light may be reflected by the lead terminals 05 to be incident on the bottoms of the light receiving elements 02, 03 as indicated by broken lines in FIGS. 6, 7.

### SUMMARY OF THE INVENTION

The present invention aims to provide a density sensor in which a light receiving element is prevented from receiving unintended light not from a subject of density detection but through different optical paths and which can improve density detection accuracy as well as to provide an image forming apparatus incorporating such a density sensor.

According to one aspect of the present invention, a density sensor which detects a density of a subject according to a variation in received light, comprises a base plate, a light emitting element irradiating a subject with light, a light receiving element receiving light reflected by the subject, lead terminals connected at one end with bottoms of the light emitting and receiving elements, respectively, and electrically connected at the other end with the base plate, and a package containing the light emitting and receiving elements and supported by the base plate, wherein at least one of the lead terminals is configured to be inclined from a halfway position so as to reflect light from the light emitting element in a direction away from the bottom of the light receiving element.

### BRIEF DESCRIPTION OF THE DRAWINGS

Features, embodiments, and advantages of the present invention will become apparent from the following detailed description with reference to the accompanying drawings:

FIG. 1 is a cross sectional view of a density sensor according to one embodiment of the present invention, seen from a S1 to S1 line in FIG. 2;

FIG. 2 is a cross sectional view of the density sensor, seen from a S2 to S2 line in FIG. 4;

FIG. 3 shows an image forming apparatus incorporating the density sensor by way of example;

FIG. 4 is a perspective view of the density sensor mounted over an intermediate transfer belt of the image forming apparatus;

FIG. 5 is a side view of a light receiving or emitting element used in the density sensor;

FIG. 6 shows a prior art density sensor; and

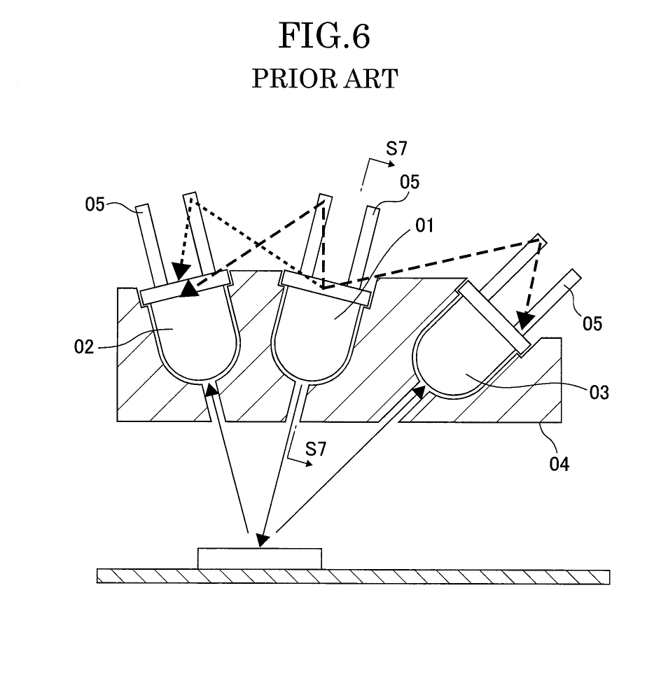

FIG. 7 is a cross sectional view of the prior art density sensor, seen from a S7 to S7 line in FIG. 6.

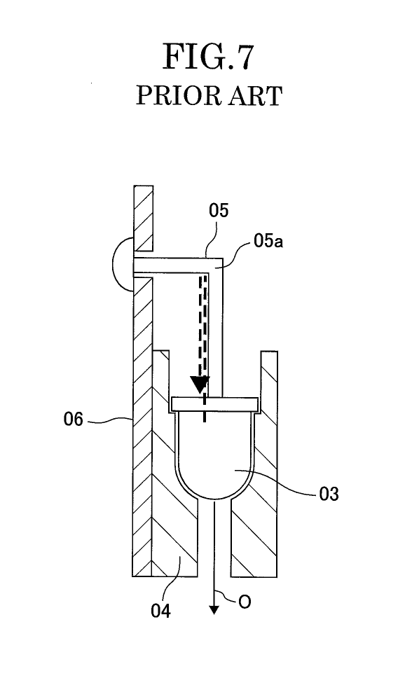

### DETAILED DESCRIPTION OF THE PREFERRED EMBODIMENT

Hereinafter, embodiment of the present invention will be described in detail with reference to the accompanying drawings.

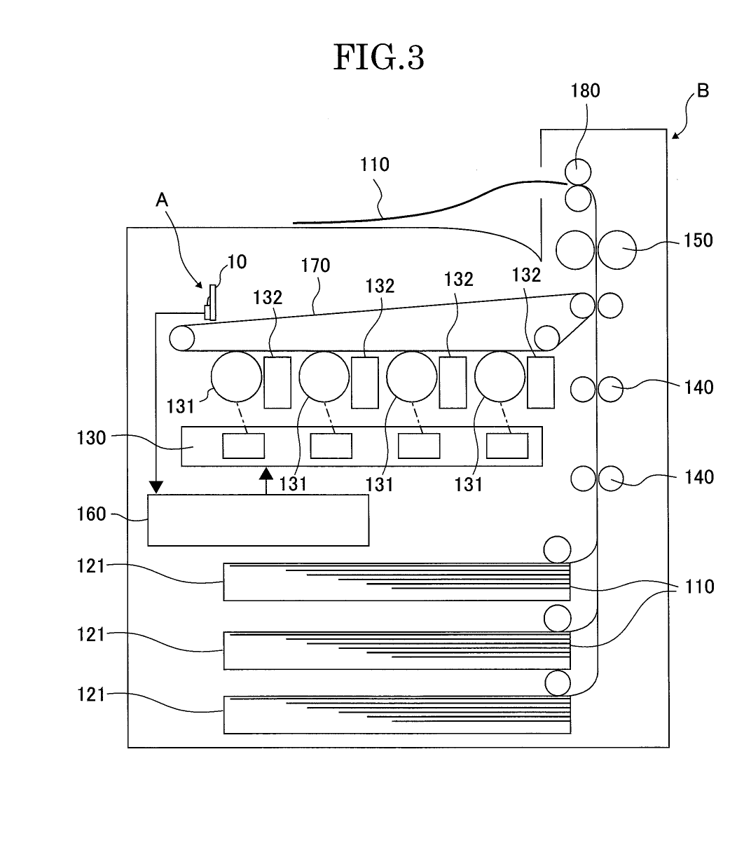

First, an example of an image forming apparatus B incorporating a density sensor A according to one embodiment of the present invention is described referring to FIG. 3. The image forming apparatus B comprises three paper cassettes 121 containing paper sheets 110, an optical write unit 130 generating toner images to be transferred onto the paper sheets 110, feed rollers 140 feeding the paper sheets 110 toward the optical write unit 130 and a fuse roller 150. The feed rollers 140 feed the paper sheets 110 to the fuse roller 150 in cooperation with a not-shown guide portion.

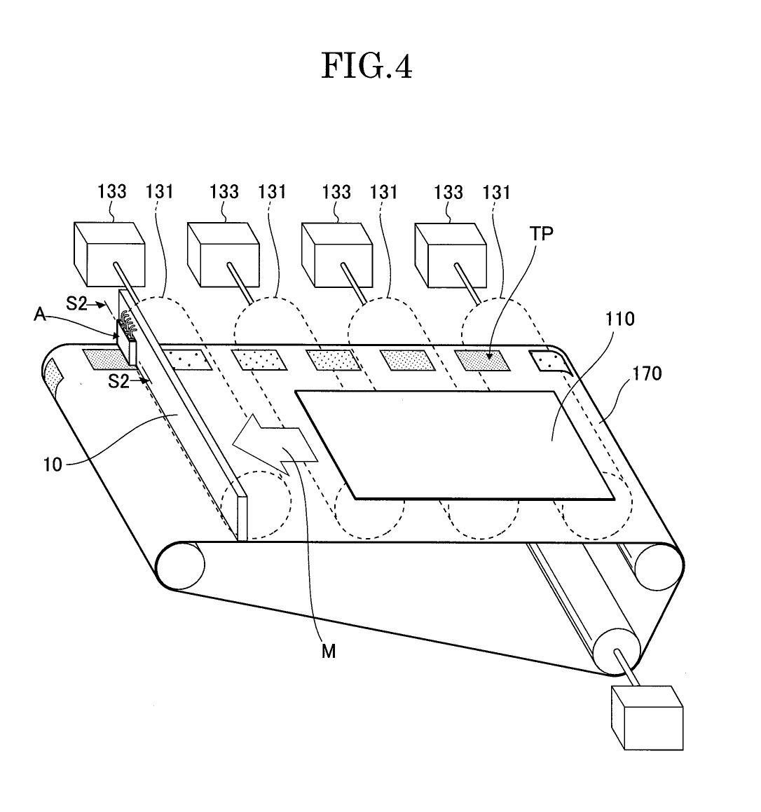

The optical write unit 130 is controlled by a controller 160 to perform color conversion, image processing and the like on image data of an image output. The optical write unit 130 includes four photoreceptor drums 131 for four colors, yellow Y, magenta M, cyan C and black BK which are rotated by drivers 133 (FIG. 4) and on which electrostatic latent images are generated. Also, not-shown charging unit, cleaning unit, and discharging units are provided for the photoreceptor drums 131.

Develop units 132 are provided for the photoreceptor drums 131 to form toner images on the photoreceptor drums 131 in accordance with the electrostatic latent images. The toner images are transferred onto an intermediate transfer belt 170 from the photoreceptor drums 131.

The toner images on the intermediate transfer belt 170 are transferred onto the paper sheet 110 fed by the feed rollers 140 and fused thereon by the fuse roller 150. Thereby, an image is generated on the paper sheet 110. The paper sheet 110 on which the image is formed is discharged by a discharge roller 180.

The image forming apparatus B comprises the density sensor A facing the intermediate transfer belt 170 with a predetermined distance. The density sensor A is supported on a base plate 10 which extends in a direction orthogonal to a moving direction (indicated by the arrow M in FIG. 4) of the intermediate transfer belt 170. Note that FIG. 4 shows only one density sensor A placed on the base plate 10, however, in reality, four density sensors A for the four colors, Y, M, C, BK are arranged thereon in the extension direction.

In order to generate full color images in high quality, the image forming apparatus B needs to make densities of images in four colors constant properly. Toner patches are created on the intermediate transfer belt 170 for references for densities of the four colors. The density sensor A is configured to optically detect the densities of the toner patches TP and adjust various parameters affecting the image density such as charge potential, exposure, developer's bias voltage, transfer voltage, toner replenishment amount based on results of the detection.

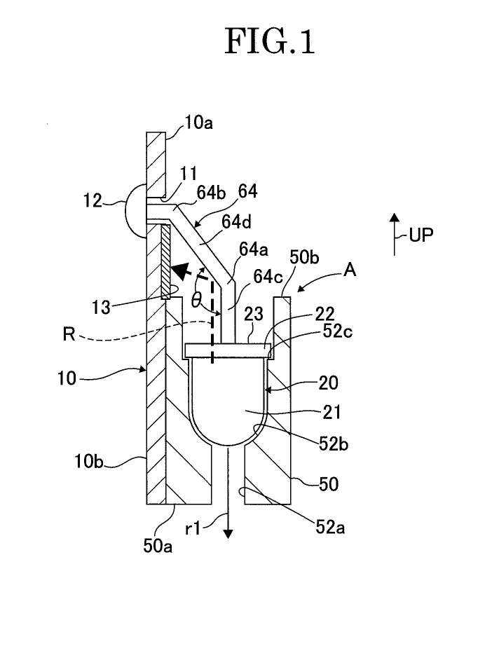

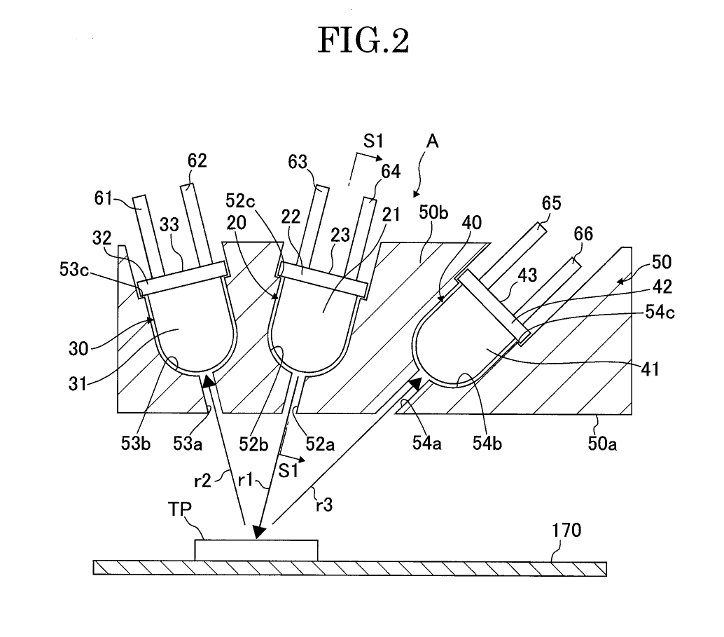

FIGS. 1, 2 cross-sectionally show the density sensor A, seen from the S1 to S1 line in FIG. 2 and the S2 to S2 line in FIG. 4. The density sensor A comprises a light emitting element 20, a specular light receiving element 30, a diffusive light receiving element 40, a package 50, and lead terminals 61 to 66 as shown in FIG. 2.

The light emitting element 20 is an infrared light emitting diode for example and irradiates the toner patches as a subject of density detection with light.

The specular light receiving element 30 and the diffusive light receiving element 40 are phototransistors or photodiodes. The specular light receiving element 30 and the diffusive light receiving element 40 detect specular light and diffusive light reflected from the toner patches TP, respectively. The density sensor A can detect densities of various color images from low to high level by detecting both of the specular light and diffusive light.

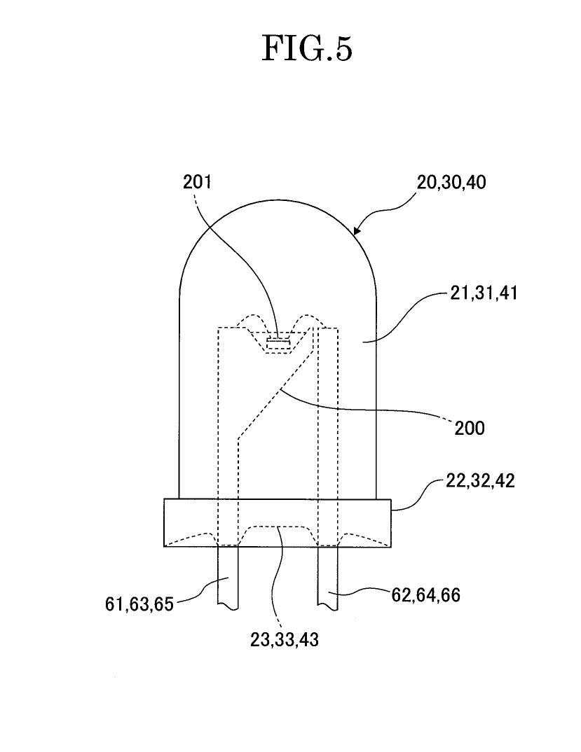

The light emitting and receiving elements 20, 30, 40 are formed in a bombshell shape. As shown in FIG. 5, they comprise cups 200 integrated with the lead terminals, LED chips 201, and molds 21, 31, 41, respectively. The LED chips 201 are mounted on the cups 200, and the molds 21, 31, 41 are formed in the cups 200 by injecting a resin in which phosphor is dispersed and molding an optically transmissive resin such as epoxy resin around the phosphoric resin. The molds 21, 31, 41 are in bombshell shape and include flanges 22, 32, 42 at a bottom having a larger diameter than that of column-like portions, respectively. The lead terminals 61 to 66 are connected with the bottoms 23, 33, 43 of the elements 20, 30, 40 and extend backward along the optical axes r1 to r3 (FIG. 2), respectively.

The package 50 is made of an optically non-transmissive material such as a black resin and forms optical paths for light from the light emitting element 20 and reflected light from the light receiving elements 30, 40. That is, the package 50 comprises, on a bottom face 50a, first to third openings 52a to 54a facing the toner patch TP for the elements 20, 30, 40, respectively. Similarly, on a top face 50b thereof, fourth to sixth openings 52b to 54b are coaxially, continuously formed with the first to third openings 52a to 54a for supporting the elements 20, 30, 40 inserted, respectively. Further, the fourth to sixth openings 52b to 54b include step portions 52c to 54c to engage with the flanges 22, 32, 42 of the elements 20, 30, 40 and adjust insertion amounts of the elements to predetermined values.

The lead terminals 61 to 66 are wired from the elements 20, 30, 40 to the base plate 10 in the same manner. Therefore, the lead terminal 64 connected with the bottom 23 of the light emitting element 20 is exemplified to describe the wiring with reference to FIG. 1. The lead terminal 64 comprises an upright portion 64c extending upward from the bottom 23 of the light emitting element 20 (indicated by the arrow UP in the drawing) along a front face 10a of the base plate 10, a first bend portion 64a bending from the end of the upright portion 64c to the base plate 10, an inclined portion 64d extending inclined from the first bend portion 64a to the base plate 10, and a second bend portion 64b bending from the inclined portion 64d in a direction orthogonal to the base plate 10. The end of the second bend portion 64b is inserted through a through hole 11 of the base plate 10 and electrically connected with a not-shown circuit by a solder element 12 on the back face 10b thereof. According to the present embodiment the lead terminals 61 to 66 are coated with an optical absorptive material such as a black coating. The other lead terminals 61 to 63, 65, 66 are structured the same as the lead terminal 64.

The through hole 11 is formed at a higher position than the light emitting element 20 so that an angle θ between the upright portion 64c and the inclined portion 64d is larger than 90 degrees (obtuse). One side face of the inclined portion 64d faces both the bottom 23 and the front face 10a of the base plate 10.

Moreover, an optical absorptive element 13 is provided on the front face 10a of the base plate 10 at a position to face the inclined portion 64d, extending from the top end 50b of the package 50 to the through hole 11 vertically. The width thereof is the same as that of the package 50 (horizontal direction in FIG. 2). The optical absorptive element 13 is also coated with an optical absorptive material as either a resist material or a silk material used in the manufacture of the base plate 10 in the present embodiment. Use of the resist material is cost-efficient while use of the silk material brings better optical absorption.

In the density sensor A according to the present embodiment, light r1 from the light emitting element 20 is reflected by the toner patch TP as specular light r2 and diffusive light r3. The specular light r2 and diffusive light r3 are received by the specular light receiving element 30 and the diffusive light receiving element 40, respectively. Image density of the toner patch is detected by measuring intensity of the light received by the elements 30, 40.

When light leaking from the bottom 23 of the light emitting element 20 travels to the inclined portion 64d of the lead terminal 64 as indicated by a broken line R in FIG. 1, it is reflected by the inclined portion 64d to the base plate 10 not to the bottoms 33, 43 of the light receiving elements 30, 40 due to its inclination to the base plate 10. Accordingly, reflected light from the lead terminals 61 to 66 are not incident on the bottoms 33, 43 of the light receiving elements 30, 40. This leads to improving density detection accuracy of the density sensor A.

Especially, in the present embodiment not part but all of the lead terminals 61 to 66 are configured to include the inclined portions. This contributes to preventing leakage of light from being incident on the bottoms 33, 43 of the light receiving element 30, 40 more effectively.

Furthermore, in the present embodiment the first bend portion 64a is bent at an obtuse angle to make the inclined portion 64d face the base plate 10. Compared to one bent at a right angle or acute angle, it is possible to further prevent reflected light from traveling to the light receiving elements 30, 40.

Moreover, in the present embodiment the lead terminals 61 to 66 are coated with the optical absorptive material so that they are not likely to reflect light from the bottom 23 of the light emitting element 20. Accordingly, incidence of light on the light receiving element 30, 40 is preventable.

Further, the density sensor A comprises the optical absorptive elements 13 on the base plate 10 at positions to face the inclined portions 64d. Therefore, the optical absorptive elements 13 can absorb reflected light (indicated by the broken line R in FIG. 1) from the lead terminals 61 to 66 and prevent it from reflected by the base plate 10 to the light receiving elements 30, 40. Unintended reflected light not from the toner patch TP is prevented from entering the bottoms 33, 43 of the light receiving elements 30, 40.

Further, the optical absorptive elements 13 are coated with either a resist material or a silk material which is used in the manufacture of the base plate 10. It is therefore unnecessary to prepare another absorptive material and add a dedicated coating work.

As described above, the image forming apparatus incorporating the density sensor according to the present embodiment can exert an improved detection accuracy of the density of the toner patch TP and accurately adjust various image forming parameters such as charge potential, exposure, developer's bias voltage, transfer voltage, toner replenishment amount based on results of the detection.

The present embodiment has described an example in which a single light emitting element and two light receiving elements are used. However, the present invention should not be limited to such an example. The numbers of these elements are arbitrarily decided.

Further, a subject of density detection by the density sensor should not be limited to the toner patch on the transfer belt. Alternatively, it can be an image on a photoreceptor, an intermediate transfer belt or a paper sheet. Further, it is applicable to other devises or apparatuses than the image forming apparatus.

Further, the present embodiment has described an example of using a resist material or a silk material of the base plate for coating the optical absorptive elements. However, the present invention should not be limited to such an example. Other coating materials with desired absorptive property can be used to adapt for a wavelength of light or to reduce reflectivity, for example. The optical absorptive elements can be made of a black fiber or a resin instead of being coated with the optical absorptive material.

Further, the present embodiment has described an example in which the lead terminals are vertically inclined to face both of the base plate and the light emitting and receiving elements. However, the present invention should not be limited to such an example. Alternatively, it can be inclined in an opposite direction to the base plate or horizontally inclined. In a case where the elements are disposed in the package so that the optical axes thereof are inclined to the front face of the base plate, the inclined portions thereof can extend orthogonally relative to the base plate as long as it is inclined to light from the light emitting elements.

In the present embodiment all of the lead terminals are inclined to reflect light from the light emitting element in a direction away from the light receiving elements. Alternatively, only a part of the lead terminals can be inclined.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. A density sensor which detects a density of a subject according to a variation in received light, comprising:
a base plate;
a light emitting element irradiating a subject with light;
a light receiving element receiving light reflected by the subject;
lead terminals connected at one end with bottoms of the light emitting and receiving elements, respectively, and electrically connected at the other end with the base plate; and
a package containing the light emitting and receiving elements and supported by the base plate, wherein
at least one of the lead terminals is configured to be inclined from a halfway position so as to reflect light from the light emitting element in a direction away from the bottom of the light receiving element.

2. A density sensor according to claim 1, wherein
the lead terminals are coated with an optical absorptive material.

3. A density sensor according to claim 1, wherein
the at least one of the lead terminals is inclined so as to reflect light from the light emitting element to the base plate.

4. A density sensor according to claim 3, wherein
the base plate includes, at a position where reflected light from the lead terminals is received, an optical absorptive portion coated with an optical absorptive material.

5. A density sensor according to claim 4, wherein
the optical absorptive material is either a resist material or a silk material which is used for the base plate.

6. An image forming apparatus comprising:
a transfer belt on which a toner patch is formed; and
a density sensor according to claim 1, detecting a density of the toner patch.

7. An image forming apparatus according to claim 6, wherein
the density sensor is provided to face the toner patch on the transfer belt and comprises a specular light receiving element receiving specular light from the toner patch and a diffusive light receiving element receiving diffusive light from the toner patch.
